(19) United States
(12) Patent Application Publication
(10) Pub. No.: US 2003/0023800 A1
(43) Pub. Date: Jan. 30, 2003

(54) Electronic data acquisition system having multi-level backplane architecture for interfacing a common host computer to non-specific target hardware through multiple PCI bridges

(76) Inventors: William Christopher Knaack, West Hills, CA (US); Burton Jay Seidman, Woodland Hills, CA (US); James Royce Morton, Valencia, CA (US)

Correspondence Address: John H. Lynn, Suite F200, 2915 Redhill Avenue, Coat Mesa, CA, 92626, US

(21) Appl. No.: 09/919,972

(22) Filed: Jul. 30, 2001

(51) Int. Cl. G06F 13/00

(52) U.S. Cl. 710/300

(57) ABSTRACT

A backplane module adds a second level of PCI bridges to a single board computer to increase the number of slots controllable by a common host processor. This invention provides a configuration that supports common host control of sixteen PCI slots and an Ethernet interface, a universal system bus (USB) and a SCSI interface resident on the common host single board computer.

### BACKGROUND OF THE INVENTION

This invention is directed to an electronic signal processing system having a multi-level backplane architecture that increases the number of personal computer interface (PCI) slots beyond the number of such slots available in conventional computer systems.

Due to the physical drive limitation of conventional PCI bridges, common host control of a single-level architecture can support at most five PCI slots. Commercially available sixteen-slot backplanes with a multilevel architecture can not support a common host SBC with single or dual Ethernet ports or a SCSI interface because of the configuration conflict that arises over how the operating system and the system basic input/output system (BIOS) treat the interrupt handling of Ethernet ports. In order to configure the SBC Ethernet ports and the SCSI interface in this architecture, the common host would lose control of up to twelve of the sixteen PCI slots.

Commercial PCI does not support user-defined input/output (I/O) within its bus structure. This poses a severe limitation to signal exchange between hardware modules occupying the various PCI slots.

### SUMMARY OF THE INVENTION

This architecture, by implementing a second level of PCI bridges, has extended the number of slots controllable by a common host processor to sixteen. This invention provides a configuration that supports common host control of sixteen PCI slots an Ethernet interface, a universal system bus (USB) and a SCSI interface resident on the common host SBC.

The I/O according to the present invention provides a backplane extension module with the same form factor as off-the-shelf backplanes. This extension module provides power supply distribution to target hardware modules not presently available in a standard PCI slot. It also provides numerous user-defined I/O for clocks, synchronization signals, and interrupts. The extension modules accommodate both single-ended and low-voltage differential signal transmission (LVDS). This extension module provides previously unavailable user-defined I/O that dramatically increases the flexibility of the PCI architecture.

A backplane extension module according to the invention for providing additional personal computer interface slots in a computer that includes host bus and a personal computer interface bus connected to the host bus comprises a plurality of personal computer interface bridge circuits connected to the personal computer interface bus and a plurality of personal computer interface slots connected to each of the plurality of bridge circuits.

The backplane extension module may further include an Ethernet port connected to the host bus. The backplane extension module may further include a universal system bus port and a small computer system interface port connected to the host bus.

The computer is preferably a single board computer that includes a bridge circuit connected to the host bus with the personal computer interface circuit being connected to the bridge. A universal system bus port may be connected to the host bus. An Ethernet port and a small computer system interface circuit may be connected to the personal computer interface circuit.

### BRIEF DESCRIPTION OF THE DRAWINGS

FIG. 1 is a block diagram of a single board computer having a multi-level backplane structure according to the present invention; and

FIG. 2 is block diagram of an alternate embodiment of a single board computer having a multi-level backplane structure according to the present invention

### DETAILED DESCRIPTION OF THE INVENTION

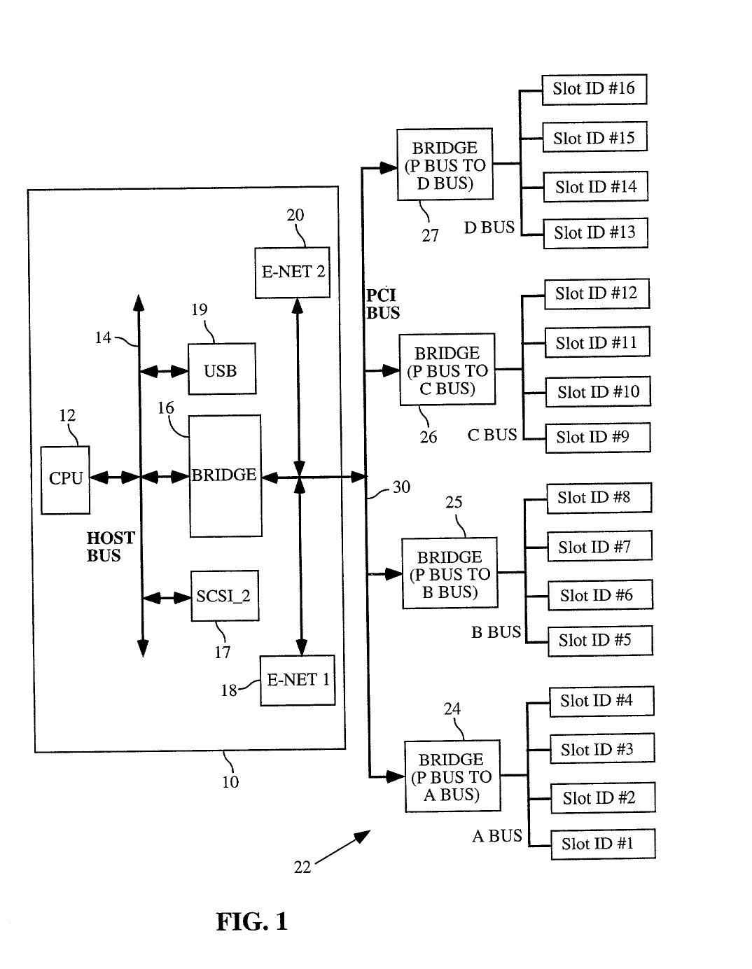

Referencing FIG. 1, a single board host computer 10 includes a central processing unit (CPU) 12, a host bus 14 and a CPU bridge 16. The CPU 12 and the CPU bridge 16 are connected to the host bus 14. A small computer system interface (SCSI) port 17 and a universal system bus port are also connected to the host bus 14. A pair of Ethernet ports 18 and 20 connected to the host bus 14. A multilevel backplane 22 is connected to the CPU bridge 16. A PCI bus 30 is connected to the CPU bridge.

The multilevel backplane 22 includes a plurality of PCI bridge circuits 24-27 is connected to the CPU bridge via the PCI bus 30. Each of the four bridge circuits 24-27 is connected to four PCI slots via corresponding busses, identified as A bus, D bus, C bus and B bus. The bridge 24 is connected to slot ID Nos. 1-4 via the A bus. The bridge 25 is connected to slot ID Nos. 5-8 via the B bus; the bus 26 is connected to slot ID Nos. 9-12 via the C bus; and the bus 27 is connected to slot ID Nos. 13-16 via the D bus.

Referencing the FIG. 1, the Ethernet ports 18 and 20 on the host bus 14 (P Bus) occupy configuration register address bits normally reserved for the A Bus (bit 27). The A Bus and B Bus configuration register addresses have been modified in hardware to occupy bits 23 and 22 respectively. The C Bus and D Bus configuration register address bits remain unchanged (bits 25 and 24 respectively). This configuration permits the Ethernet ports 18 and 20 to be configured without conflicting with the A, B, C, or D Bus configurations. This configuration also provides common host control of the Ethernet port 18 and all sixteen PCI slots. The system BIOS is configured for plug and play operation that is supported by all conventional operating systems such as Windows 95, 98, 2000, and NT. The software drivers for individual target hardware are modified to detect any modifications made by the operating system to the configuration registers in the bridge chips as part of boot (cold start) or reset (warm start). When the driver detects a register modification (the operating system typically sets up the configuration registers in the bridge chips to a default value), it responds by reconfiguring the register such that interrupt protocol and communications between the driver, the target hardware and the common host is restored. Without the smart driver-driver capability, this type of event is detrimental to proper system operation. This feature is not currently supported by off-the-shelf driver software for third-party hardware modules.

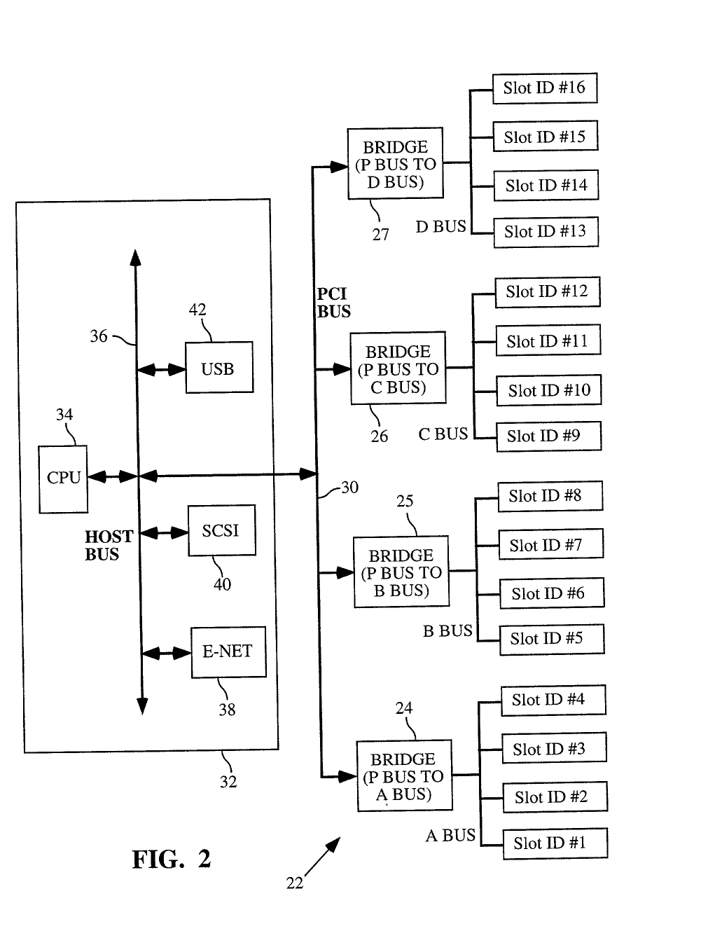

Referencing FIG. 2, a single board host computer 32 includes a CPU 34 and a host bus 36. The single board host computer 32 also includes an Ethernet port 38, a small computer system interface (SCSI) port 40 and a universal system bus (USB) port 42 connected to the host bus 36. The PCI bus 30 is connected directly to the host bus 36.

The backplane extension module 22 provides interfaces to auxiliary power supply modules that are not typically supported by an off-the-shelf PC chassis. This provides a method for supplying additional power supplies to target hardware in the PCI slots that are not normally provided by the standard PCI interface connector. The backplane extension module 10 provides a standard EDAC connector for extending the capabilities of the ISA bus connector and provides standard IDC connectors for expanding the capabilities of the PCI bus connectors. The backplane extension module 10 maintains the integrity of the commercial PCI backplane form factor, and supports both single-ended and LVDS differentially driven I/O.

The structures and methods disclosed herein illustrate the principles of the present invention. The invention may be embodied in other specific forms without departing from its spirit or essential characteristics. The described embodiments are to be considered in all respects as exemplary and illustrative rather than restrictive. Therefore, the appended claims rather than the foregoing description define the scope of the invention. All modifications to the embodiments described herein that come within the meaning and range of equivalence of the claims are embraced within the scope of the invention.

What is claimed is:

1. A backplane extension module to provide additional personal computer interface slots in a computer that includes host bus and a personal computer interface bus connected to the host bus, comprising:
a plurality of personal computer interface bridge circuits connected to the personal computer interface bus; and
a plurality of personal computer interface slots connected to each of the plurality of bridge circuits.

2. The backplane extension module of claim 1, further comprising an Ethernet port connected to the host bus.

3. The backplane extension module of claim 2, further comprising a universal system bus port connected to the host bus.

4. The backplane extension module of claim 3, further comprising a small computer system interface port connected to the host bus.

5. The backplane extension module of claim 1 wherein there are four personal computer interface bridge circuits connected to the personal computer interface bus.

6. The backplane extension module of claim 5 wherein each of the four personal computer interface bridge circuits has four personal computer interface slots.

7. The backplane extension module of claim 1 wherein the computer is a single board computer that includes a host bus and a bridge circuit connected to the host bus and wherein the personal computer interface circuit is connected to the bridge.

8. The backplane module of claim 7, further comprising a universal system bus port connected to the host bus.

9. The backplane module of claim 8, further comprising an Ethernet port connected to the personal computer interface circuit.

10. The backplane module of claim 9, further comprising a small computer system interface circuit connected to the personal computer interface circuit.
